(19) United States
(12) Patent Application Publication
(10) Pub. No.: US 2015/0363747 A1
(43) Pub. Date: Dec. 17, 2015

(54) Method and System for Creating in Real-Time, a Day-Specific Online Record of Events, Social Networking, and an Online Community of Users

(71) Applicant: Dinesh AGARWAL, Burke, VA (US)

(72) Inventor: Dinesh AGARWAL, Burke, VA (US)

(21) Appl. No.: 14/410,126

(22) PCT Filed: Mar. 4, 2013
(86) PCT No.: PCT/US13/28809

§ 371 Date: Dec. 22, 2014

Related U.S. Application Data
(60) Provisional application No. 61/664,017, filed on Jun. 25, 2012.

(51) Int. Cl. G06Q 10/10; G06Q 50/00

(52) U.S. Cl. CPC G06Q 10/1093; G06Q 50/01

(57) ABSTRACT

A computer-implemented method of creating in real-time, a day-specific online record of events, includes i) having an electronic device with a capability to receive user input information and storing on the same device or transmitting to a remote computer, or both, ii) inputting, using the electronic device, on one day of a week (month or year) information relating to at least one event that occurred on the same day of any of the previous weeks (or months or years), and repeating the inputting step on the same day of at least any one week (or month or year) thereafter.

### CROSS-REFERENCE TO RELATED APPLICATIONS

The present application claims priority on prior U.S. Provisional Application Ser. No. 61/664,017, filed Jun. 25, 2012, which is hereby incorporated herein in its entirety by reference.

### FIELD AND BACKGROUND OF THE INVENTION

The present invention is directed to a method and system for creating in real-time, a day-specific online record of events, social networking, and an online community of users.

The internet sites such as Facebook.com, Twitter.com, etc., have provided platforms for social networking. The users create their profiles, which are then generally updated with new information about themselves or others. Users also interact with other users by exchanging or sharing information, thoughts, feelings, life events, including pictures, videos, links, etc., and posting comments/responses to the comments/responses of others. The users generally have unrestricted access to their own profiles, as well as those of others, and are typically free to upload/download any information within the bounds of a site's guidelines, policies, and/or the applicable laws.

Facebook recently introduced a new kind of profile where the users can feature history or chronology of life events as they happened in time. At ancestry.com, users can trace/search their ancestors, lineage, etc., and evite.com allows users to create a guest list for invitation/RSVP purposes. Likewise, friendsreunited.com allows users to find, collect and share the memories that matter to them, and connect with people and places. Yet another application, peoplecube.com, arranges meetings with a group of people in the future at a location for a specific topic. Also, collaborative software allows social/networking of individuals working on a project.

Various methods and systems are illustrated in U.S. Pat. Nos. 7,685,530B2; 7,761,322B2; 8,010,458B2; 8,032,510B2; 8,095,406B2; 8,145,678B2; 8,150,718B2; 8,155,630B2; 8,180,807B2; 2008/0242277A1; 2009/0215469A1 2009/0254831A1; 2010/0050086A1; 2010/0050087A1; 2010/0050123A1 and 2010/0058193A1.

### ASPECTS OF THE INVENTION

The present disclosure is directed to various non-limiting aspects of the present invention.

One aspect of the present invention is a method and system for social networking based on a specific day, such as a birthday, anniversary, graduation day, holiday, special event day (e.g. Super Bowl), personal event day (e.g., bought my first car, started a new (or first) job, won Nobel Prize, immigrated to the U.S., became a naturalized U.S. citizen) etc.

Another aspect of the present invention is a method and system for social networking, wherein on a specific or selected day of a week, month, and/or year, the users of the system interact (exchange, record, discuss, comment, talk, share, etc.) with other users about event(s) that occurred on the same day of any previous week, month, and/or year. Further, they can also refer to the event(s) already occurred or occurring in real-time on the specific or selected day, or to occur later that day.

Another aspect of the present invention is a method and system for social networking, wherein the emphasis or focus of interaction, exchange, sharing, commenting, etc., is on a specific calendar or non-calendar day of the past, what is to occur in the present day today, or is occurring in real-time today, and/or is to occur on the same day in the future.

Another aspect of the present invention is a method and system for social networking, wherein the users share, exchange, and/or comment on thoughts, memories, pictures, etc., or otherwise interact, on a specific or selected present calendar or non-calendar day, only about the memories, thoughts, feelings, events, etc., that occurred on the same day of any previous week, month, and/or year. For example, on May 19, 2012, the users of the system would only talk, comment, discuss, and/or share information, or otherwise interact with other users, about events (including thoughts, memories, pictures, videos, etc.) that occurred on, for example, a year ago on May 19, 2011 (or 2010, 2009, etc.), or one or more months ago on Apr. 19, 2012, Mar. 19, 2012, Feb. 19, 2012, etc. Further, the users would talk, discuss or share information about the events of the present day, or those occurring in the present day in real-time, or to occur later today. Although not necessary, the past event(s) and the event(s) of the present day, would preferably be related for an exciting and comparable interaction. As another example, on New Year's Day, Jan. 1, 2012, the users would only share their thoughts, memories, pictures, or any other information, or otherwise interact, about a previous New Year's Day, e.g., Jan. 1, 2011 (or 2010, 2009, 2008, etc.) Further, the users would talk about, discuss, share their thoughts, pictures, video, etc., about Jan. 1, 2012, including as to what is happening in real-time; at midnight, for example. The users would also share/exchange their thoughts, details, etc., about the next New Year's Day on Jan. 1, 2013.

Another aspect of the present invention is a computer-implemented method of creating in real-time, a day-specific online record of events, wherein a user interacts with his/her profile and/or other users on a calendar and/or non-calendar day, by relating to at least one event that occurred on the same calendar and/or non-calendar day of any previous week(s), month(s), or month(s), or at any other fixed period or interval of time. The user can also interact by relating to at least one event occurring in real-time or to occur on the present calendar and/or non-calendar day, and/or on the same day in the future.

Another aspect of the present invention is a method and system for social networking, wherein a common theme that brings the users together for interaction is a particular or selected day from the past, and/or as it relates to the present day today after a fixed period of time, and/or the same day in the future.

Another aspect of the present invention is a computer-implemented method of creating in real-time, a time frame-specific online record of events, wherein a user interacts with his/her profile and/or other users in a specific or selected time frame, or on a calendar and/or non-calendar day of a specific or selected time frame, by relating to at least one event that occurred in the same time frame of any previous week(s), month(s), or month(s), or at any other fixed period or interval of time. The user can also interact by relating to at least one event occurring in real-time or to occur in the same present time frame, or on the present calendar and/or non-calendar day or the same time frame, and/or on the same day and/or time frame in the future.

Another aspect of the present invention is a method and system for social networking, wherein a common theme that brings the users together for interaction is a particular or selected time frame from the past, and/or as it relates to the present time frame after a fixed period of time, and/or the same time frame in the future.

Another aspect of the present invention includes a computer-implemented method of creating in real-time, a day-specific online record of events, which includes a) having an electronic device with a capability to receive user input information and storing on the same device or transmitting to a remote computer, or both; b) inputting, using the electronic device, on one day of a calendar month information relating to at least one past event that occurred on the same day of any of the previous months; and c) repeating step b) on at least one succeeding day through the last day of the calendar month.

Another aspect of the present invention includes a computer-implemented method of creating in real-time, a day-specific online record of events, which includes a) receiving from at least one user on one day of a calendar month, and storing on a computer, information relating to at least one past event that occurred on the same day of any of the previous months; and b) repeating step a) on at least one succeeding day through the last day of the calendar month.

Another aspect of the present invention includes a computer-implemented method of creating in real-time, a day-specific online record of events, which includes a) receiving from at least one user on a calendar day or a non-calendar day, and storing on a computer, information relating to at least one event that occurred on the same day of a prior week, a prior month, or a prior year; and b) receiving from the user on the calendar day or the non-calendar day, and storing on the computer, information relating to at least one event occurring in real-time, or to occur, on the calendar day or the non-calendar day.

Another aspect of the present invention includes a computer-implemented method of creating in real-time, a day-specific online record of events, which includes a) receiving from at least one user on a calendar day or a non-calendar day, and storing on a computer, information relating to at least one event to occur on the same day of a week, a month, or a year in the future; and b)receiving from the user on the calendar day or the non-calendar day, and storing on the computer, information relating to at least one event occurring in real-time, or to occur, on the calendar day or the non-calendar day.

Another aspect of the present invention includes in a computer system, an online social networking method, which includes a) receiving a day-specific information relating to a past event transmitted by at least one user on the same day of any week, month, or year thereafter; and b) allowing another user access to the day-specific information and to transmit a response receivable by the at least one user.

Another aspect of the present invention includes an online community of users, which includes a) a plurality of profiles of respective users stored on a computer; b) the profiles being accessible by the respective users via a computer, or a mobile electronic device comprising a cellphone, a smartphone, a tablet, a personal digital assistant (PDA), a laptop, or a combination thereof; and c) at least one of the profiles including a day-specific information relating to a past event transmitted by the respective user on the same day of any week, month, or year thereafter.

Another aspect of the present invention includes a computer-implemented method of creating in real-time, a day-specific online record of events, which includes a) having an electronic device with a capability to receive user input information and storing on the same device or transmitting to a remote computer, or both; b) inputting, using the electronic device, on one day of a week information relating to at least one event that occurred on the same day of any of the previous weeks; and c) repeating step b) on the same day of at least any one week thereafter.

Another aspect of the present invention includes a computer-implemented method of creating in real-time, a day-specific online record of events, which includes a) having an electronic device with a capability to receive user input information and storing on the same device or transmitting to a remote computer, or both; b) inputting, using the electronic device, on one day of a month information relating to at least one event that occurred on the same day of any of the previous months; and c) repeating step b) on the same day of at least any one month thereafter.

Another aspect of the present invention includes a computer-implemented method of creating in real-time, a day-specific online record of events, which includes a) having an electronic device with a capability to receive user input information and storing on the same device or transmitting to a remote computer, or both; b) inputting, using the electronic device, on one day of a year information relating to at least one event that occurred on the same day of any of the previous years; and c) repeating step b) on the same day of at least any one year thereafter.

Another aspect of the present invention includes a computer-implemented method of creating in real-time, a day-specific online record of events, which includes a) receiving from at least one user on one day of a month, and storing on a computer, information relating to at least one event that occurred on the same day of any of the previous months; and b) repeating step a) on the same day of at least any one month thereafter.

Another aspect of the present invention includes a computer-implemented method of creating in real-time, a day-specific online record of events, which includes a) receiving from at least one user on one day of a week, and storing on a computer, information relating to at least one event that occurred on the same day of any of the previous weeks; and b) repeating step a) on the same day of at least any one week thereafter.

Another aspect of the present invention includes a computer-implemented method of creating in real-time, a day-specific online record of events, which includes a) receiving from at least one user on one day of a year, and storing on a computer, information relating to at least one event that occurred on the same day of any of the previous years; and b) repeating step a) on the same day of at least any one year thereafter.

### BRIEF DESCRIPTION OF THE DRAWINGS

One or more of the above and other aspects, novel features and advantages of the present invention will become apparent from the following detailed description of a preferred embodiment(s) of the invention, as illustrated in the drawings, in which:

FIG. 1 is a schematic illustration of a preferred embodiment of a networking method in accordance with the present invention;

FIG. 2 is a flow chart of a preferred embodiment of a method of creating in real-time, a day-specific online record of events;

FIG. 3 is a schematic illustration of a sample user interface for use in creating in real-time, a day-specific online record of events;

FIG. 4 is a schematic illustration of the sample user interface of FIG. 3, shown with the information from a user based on a month;

FIG. 5 is a schematic illustration of the sample interface of FIG. 3, shown with the information from a user based on a year;

FIG. 6 is a schematic illustration of the sample interface of FIG. 3, shown with the information from a user based on a year;

FIG. 7 is a schematic illustration of the sample interface of FIG. 3, shown with the information from a user based on a year; and

FIG. 8 is a partial illustration of the sample interface of FIG. 4, showing responses from other user(s) represented by balloons.

### DETAILED DESCRIPTION OF THE PREFERRED EMBODIMENT(S) OF THE INVENTION

The present invention is based, at least in part, on the recognition that while we as a society celebrate many holidays, such as the New Year's Day, President's Day, Valentine's Day, Memorial Day, Mother's Day, Father's Day, Independence Day, Labor Day, Halloween, Veteran's Day, Thanksgiving, Christmas, etc., many events are unique and/or personal to different people and occur on different days of a week, month, and/or year. For example, people get married, go on vacation(s), or buy their first car on different days. Likewise, on any given day, different people are engaged in different activities, and/or involved in or associated with different events.

Further, different days, such as high school and college graduations are recognized or celebrated by different segments of people in the society. Likewise, people of different faith or religion follow their own holidays. There are also historic days, such as December 7^{th}, when the Pearl Harbor was attacked.

In summary, an event on a particular day, whether in the past, in the present day, or in the future is either unique or individual to us as a person, and/or is related or connected to another person, the society and/or the environment in some fashion.

One purpose of the present invention is, therefore, to stimulate and engage in social networking on a specific or selected day, but only about the event(s) that occurred on the same calendar or non-calendar day, a fixed period ago in the past, and/or about the event(s) (preferably related, but also unrelated) occurring in real-time (or to occur) in the present day. The fixed period can be, for example, a week, a month, or a year, or any other desired length of time, such as a quarter, bi-week, six months, four years (leap year), etc. Further, this type of social networking can extend to the same (or different) fixed period in the future.

Another purpose of the present invention is to encourage people, especially the elder segment of the society, to share and make record of past events, memories, feelings, experiences, etc., for the benefit of others and future generation(s). Apropos is the regret of a well-known Hollywood actress, Michelle Pfeiffer, who recently lamented:
One of my biggest regrets is that I didn't get [my dad's] life story before he died. I didn't dig it out of him. He was really private.
Rader, D. Michelle Pfeiffer What She Knows. Parade, The Washington Post, May 6, 2012 (pp. 9-10, 12-13 and 16).

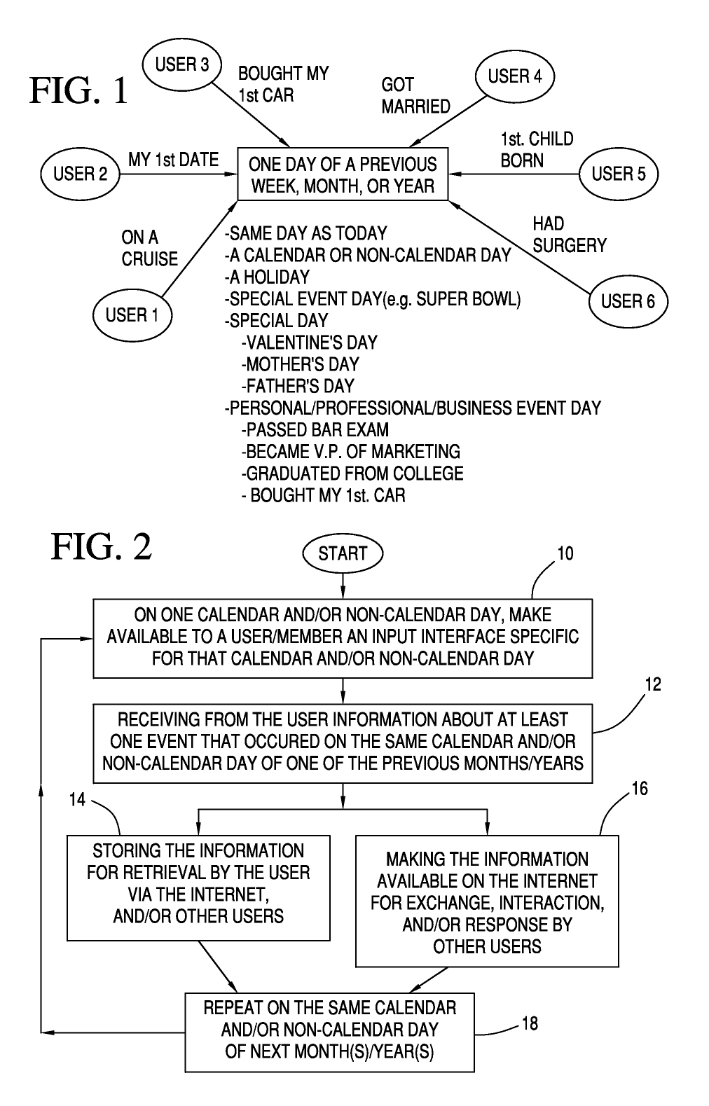

The overall concept of a preferred embodiment of the present invention is illustrated in FIG. 1. As shown, on a selected or particular calendar and/or non-calendar day, various users of a social networking system, such as facebook.com or twitter.com, interact with other users by providing information about an event(s) that occurred on the same day of a previous week, a previous month, or a previous year. For instance, six-months ago on the same day as today, User 1 was on a cruise, while User 6 had some sort of surgery. Likewise, while User 2 had his/her first date, User 4 got married on that day. In the same manner, User 3 bought his/her first car, and user 5 had his/her first child born, all on the same day as today, but six months ago.

As illustrated in FIG. 1, the day can be a calendar day, a holiday, a special event day (Super Bowl), a special day (Valentine's day, Mother's day, Father's day), and/or a personal/professional/business event day, such as having passed a bar exam or received a promotion at work. A day can also be a non-calendar day, such as summer or winter solstice. These days don't always fall on the same calendar day every year. Likewise, some holidays do not always fall on the same calendar day every year, such as Halloween and Thanksgiving Day. Many religions also follow their own calendar and have their holidays or events recognized or celebrated on different calendar days each year. Along the same lines, February 29^{th} only comes around every four years, in a leap year.

Referring to FIG. 2, a preferred embodiment of a computer-implemented method of creating in real-time, a day-specific online record of events will now be described. It is noted herewith that the method would preferably be executed on a system, such as facebook.com or twitter.com, where a user has already become a member of their platform, and/or has a basic profile that is necessary to be a user of their system. Alternatively, a separate or independent, or a self-standing computer system or website can be developed to execute the method of the present invention.

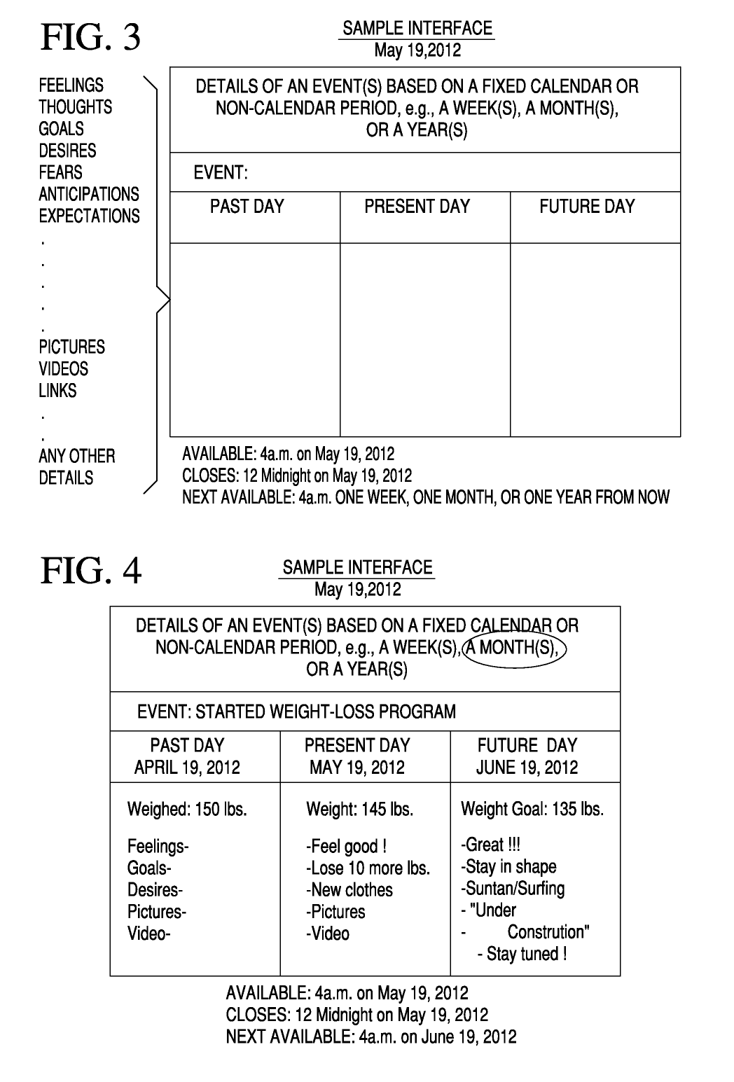

On one calendar and/or non-calendar day, the system would make available to a user/member a user interface that is specific for that calendar and/or non-calendar day, i.e., the present day (step 10). As an illustration, as shown in FIG. 3, a sample interface would be made available, for example, at 4 am, on May 19, 2012, to have the user/member input information about an event that occurred on, for example, a month ago on Apr. 19, 2012 (step 12 and FIG. 4). This interface would be available to the user/member only for that day, i.e., May 19, 2012, and close at 12 o'clock midnight on May 19, 2012. During this time, the user is free to interact through the interface as much as he/she likes or as many times as desired. It is noted that while it is preferred that the user interface be made available for interaction only for one specific day, it is within the scope of the present invention to extend this availability to more than one day, or shorten to any period of less than one day.

As illustrated in more detail in FIG. 4, the user would input details about an event (Started Weight-Loss Program) that occurred a month ago on Apr. 19, 2012, as well as details of the event as of the present day, i.e., May 19, 2012. Further, the user can also input details about the event as he/she sees in the future, one month from now on Jun. 19, 2012.

As illustrated in FIG. 3, the user can input information about, including but not limited to, his/her feelings, thoughts, goals, desires, fears, anticipations, expectations, etc., as well as post or upload pictures, videos, etc., and post any related links, or any other details as they relate to the event a month ago, as of today, and/or as of a month in the future.

The user-input information is processed, if necessary, and stored for retrieval by the user via the internet, and/or other users (step 14), and preferably, also made available on the internet (or other similar network, protocol, system, or platform available now or created in the future) for exchange, interaction, and/or response by other users (step 16).

As also illustrated in FIG. 4, since the user has selected inputting of the details about an event on a monthly basis, the next time this interface would be available to the user for editing or modifications, is one month from now, i.e., 4 am on Jun. 19, 2012. Although, the sample interface is not available for editing in-between, it can nonetheless be made available for viewing purposes only. One month later, on Jun. 19, 2012, the system would again make the sample interface available to the user for editing and for interaction with other users (step 18). Therefore, in this method, the sample interface would be available to the user for editing (and for interaction with other users) every month on the same day, i.e., the 19^{th}.

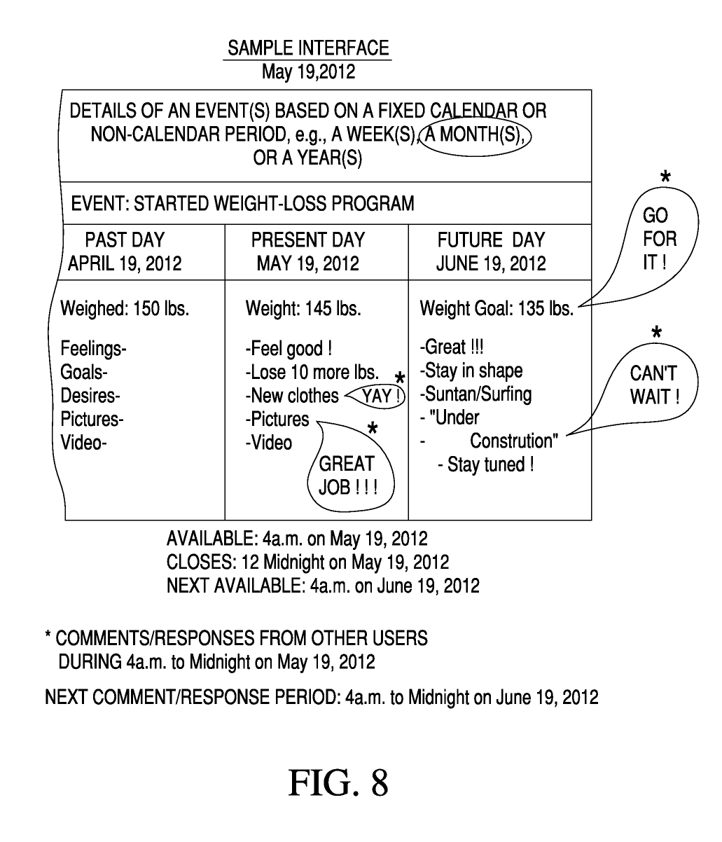

As illustrated in FIG. 8, when the sample interface is made available to the user on, for example, May 19, 2012, it is also available to other users/members to interact with the user via the sample interface to respond by, for example, posting, sharing, or exchanging comments, pictures, videos, links, etc.

As shown in FIG. 8, on May 19, 2012, when the sample interface is available for editing, another user can view the details of the event (FIG. 4) and post comments that, for example, appear as balloons, on the user's profile. It may be desirable to have, for instance, green, blue, and red balloons to indicate positive, neutral, negative responses, respectively. Alternatively, or in addition, upwardly, downwardly, or horizontally oriented balloons may be used to indicate strength or type of the emotion expressed by the comment or response from another user.

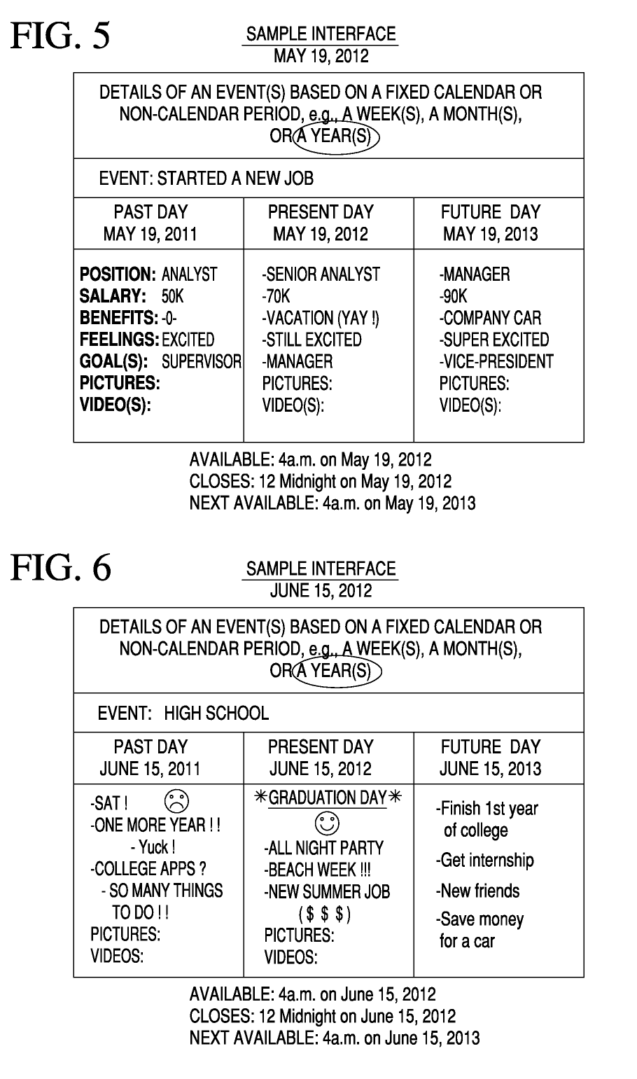

FIGS. 5-7 illustrate various other sample interfaces, which can be made available to a user on a yearly basis. Specifically, FIG. 5 illustrates an example of a sample interface where the event is that a user had started a new job a year ago on May 19, 2011, and the present day is May 19, 2012, and the future day is May 19, 2013.

Likewise, FIG. 6 illustrates another yearly sample interface where the event is graduation from high school in the present day on Jun. 15, 2012. The user inputs information (including feelings, posting or uploading pictures, videos, etc.) as of one year ago, and his/her plans as of one year from now, i.e., Jun. 15, 2013. Additionally, the user inputs information about the event(s), plan(s), etc., for the present day, which is today, Jun. 15, 2012, and/or any information or details, pictures, videos, etc. about any event(s) that are occurring in real-time. For example, the user can post comments, feelings, pictures, videos, etc., in real-time from the graduation ceremony, all night party, etc.

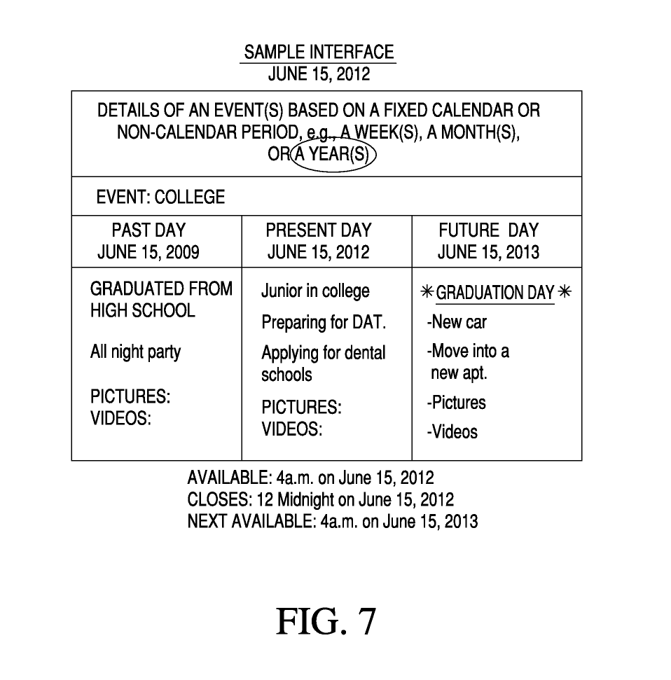

FIG. 7 illustrates another yearly sample interface available to a user on the present day, which is Jun. 15, 2012. However, since the emphasis of the event is graduation from college, the past day stretches back three years to when the user had graduated from high school on the very same day, i.e., Jun. 15, 2009.

The present invention includes an embodiment where a user inputs information about an event(s) of the present day, without referring back to the past, and continues thereafter in the future.

It is noted that while the present invention is described/illustrated in terms of a specific day or selected day of a week, month, and/or year, it includes a specific or selected timeframe or event, that spans across more than a day. For instance, Mardi Gras celebrations begin on the Friday before the main event on the following Tuesday. Likewise, cricket test matches between countries, including India, England, Australia, New Zealand, Sri Lanka, and West Indies, span across multiple days. In yet another example, it is not uncommon for a Hindu wedding to consume a full week of religious celebrations.

It is noted herewith that the method(s) of the invention need not be performed in the order written or as recited in claims. They can be performed in a different order.

It is noted herewith that a computer for use in the present invention would need to be specifically designed and/or programmed in order to execute various steps, including, for example: making available a day-specific user interface only on the actual day of a specific or selected week, month, or year; receiving input(s) from user(s) on the specific day, processing, and storing for retrieval; allowing user(s) to edit information only on the actual day(s); allowing users to only view the day-specific information on other days, etc. To that end, the computer or system would preferably include, or be in the form of a computing device, that includes at least one processor, at least one memory, at least one input port, and/or at least one output port, or equivalent components thereof, available now or in future. The processor can be multiple core, dual core, quad core, etc., or equivalents thereof, available now or in future. The storage component cam be SAN, RAID, etc., or equivalents thereof, available now or in future. The database used/created can be rational or SQL, or equivalents thereof, available now or in future. The server type can be load balancing, front end/back end architecture, mirrors, etc., or equivalents thereof, available now or in future. Any communication of date or information can be via Ethernet (preferably 1000Base T) or wireless (preferably 102.11 b/g/n), or equivalents thereof, available now or in future.

As used herein, the term “information” includes, but not limited to, any information communicable/transmittable via electronic means, and includes textual matter, graphic matter, pictures, audios, videos, links, etc., and feelings, thoughts, experiences, goals, desires, fears, anticipations, expectations, etc.

As used herein, the term “inputting” includes, but not limited to, keying, entering, texting, uploading, downloading, transferring, referring, re-routing, etc., or otherwise transmitting to and/or communicating with another computer, network of computers, website, internet, portable or mobile electronic device (available now or in future), other users, any information.

As used herein, the term “event” includes, but not limited to, any life event or occurrence, direct or indirect, that is personal, professional, educational, academic, sports, social, political, geographical, governmental, natural, recreational, environmental, economical, and/or any activity in a field of endeavor, whether for recreation or for occupation.

As used herein, the term “profile” includes, but not limited to, any information about or relating to a user or entity (e.g., private, corporate, governmental, profit or non-profit) stored or present in any form in a computer, server, network of computers, etc., whether created for the first time, re-created at any time in any form, retrieved by any user in any form at any time, in any edited, modified, or revised form, or as created originally.

As used herein, the term “interaction” includes, but not limited to, inputting information, editing, modifying, and/or revising profile, posting information, writing on virtual profile, commenting on or otherwise reacting to information or profile, sharing information, exchanging information, responding, uploading, downloading, referring, re-routing, and/or transferring information, texting, and/or otherwise communicating via the internet, a network of computers or servers, online, a website, a social networking system or platform (available now or in future).

As used herein, the term “computer” includes, but not limited to, computer, server, network of computers or servers, internet, global network of computers, website, social networking system or platform, or a similar device available now or in future.

While this invention has been described as having preferred sequences, ranges, steps, order of steps, materials, structures, shapes, configurations, features, components, or designs, it is understood that it is capable of further modifications, uses and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

1-15. (canceled)

16. A computer-implemented method of creating in real-time, a day-specific online record of events, comprising the steps of:
a) receiving from at least one user on a calendar day or a non-calendar day, and storing on a computer, information relating to at least one past event that occurred on the same day of any prior week, any prior month, or any prior year; and
b) repeating step a) on at least one same calendar day or non-calendar day of a week, month, or year subsequent to the prior week, the prior month, or the prior year.

17. The method of claim 16, comprising:
making available a user interface specific for the calendar day or non-calendar day but only on that day.

18. The method of claim 17, comprising:
making available a user interface specific for each day of calendar months, including January, February, March, April, May, June, July, August, September, October, November, and December.

19. (canceled)

20. The method of claim 17, comprising:
allowing the user to edit any previous entries and/or add new entries via the specific user interface only on the same calendar day or non-calendar day.

21. (canceled)

22. The method of claim 16, comprising:
receiving from the user information relating to at least one present event occurring in real-time, or to occur on the same calendar day or non-calendar day in step b).

23. The method of claim 22, wherein:
the one day is a birthday, an anniversary, a graduation day, a holiday, Valentine's Day, Halloween, Election Day, Father's Day, Mother's Day, Administrative Professionals, Day, a solstice, a festival day, a historic day, a disaster day, or a Super Bowl day, or a combination thereof.

24. (canceled)

25. The method of claim 22, wherein:
the past event and the present event are related in nature.

26. The method of claim 16, comprising:
receiving and storing user input information from multiple users; and
making available individual user interfaces to respective users for the calendar day or non-calendar day but only on that day.

27-29. (canceled)

30. A computer-implemented method of creating in real-time, a day-specific online record of events, comprising:
a) receiving from at least one user on a calendar day or a non-calendar day, and storing on a computer, information relating to at least one event that occurred on the same day of a prior week, a prior month, or a prior year; and
b) receiving from the user on the calendar day or the non-calendar day, and storing on the computer, information relating to at least one event occurring in real-time, or to occur, on the calendar day or the non-calendar day.

31. The method of claim 30, comprising:
making available a user interface specific for the calendar day or the non-calendar day but only on that day.

32. The method of claim 31, comprising:
allowing the user to edit any entries or add new entries via the specific user interface only on the calendar day or the non-calendar day.

33. The method of claim 32, comprising:
repeating steps a) and b) concurrently, consecutively, or in reverse order at least one week, month, or year thereafter.

34. The method of claim 32, comprising:
the calendar day or the non-calendar day is a birthday, an anniversary, a graduation day, a holiday, Valentine's Day, Halloween, Election Day, Father's Day, Mother's Day, Administrative Professionals Day, a solstice, a festival day, a historic day, a disaster day, or a Super Bowl day, or a combination thereof.

35-39. (canceled)

40. In a computer system, an online social networking method, comprising the steps of:
receiving a day-specific information relating to a past event transmitted by at least one user on the same day of any week, month, or year thereafter; and
allowing another user access to the day-specific information, and to transmit only on the same day of any week, month, or year thereafter a response receivable by the at least one user.

41. (canceled)

42. The method of claim 40, comprising:
allowing the at least one user to transmit the day-specific information via a mobile electronic device comprising a cellphone, a smartphone, a tablet, a personal digital assistant (PDA), a laptop, or a combination thereof.

43. The method of claim 42, comprising:
allowing the another user access to the day-specific information via a mobile electronic device comprising a cell phone, a smartphone, a tablet, a personal digital assistant (PDA), a laptop, or a combination thereof.

44. The method of claim 40, comprising:
including the day-specific information in a pre-existing record of the at least one user; and
wherein the pre-existing record comprises a profile.

45-57. (canceled)

58. The method of claim 30, comprising:
receiving from the user on the calendar day or the non-calendar day, and storing on the computer, information relating to at least one event to occur on the same day in the future.

59. The method of claim 40, comprising:
receiving from the user or another user day-specific information relating to at least one event to occur on the same day in the future.

60. The method of claim 40, wherein:
the at least one user and the another user were both present at the past event.
